(19) United States
(12) Patent Application Publication
(10) Pub. No.: US 2025/0193983 A1
(43) Pub. Date: Jun. 12, 2025

(54) LIGHTING DEVICE WITH CURRENT SELF-BALANCING FUNCTION

(71) Applicant: Xiamen PVTECH Co., Ltd., Xiamen (CN)

(72) Inventors: FUXING LU, Xiamen (CN); Zhirong Lin, Xiamen (CN)

(73) Assignee: Xiamen PVTECH Co., Ltd., Xiamen (CN)

(21) Appl. No.: 18/964,660

(22) Filed: Dec. 1, 2024

(30) Foreign Application Priority Data
Dec. 8, 2023 (CN) 202311759368.1

(51) Int. Cl. H05B 45/46; H05B 45/35

(52) U.S. Cl. CPC H05B 45/46; H05B 45/35

(57) ABSTRACT

A lighting device includes an input module, a first light-emitting module, a second light-emitting module, and a current adjusting module. The input module includes a first input terminal and a second input terminal. The first light-emitting module includes a plurality of first light sources connected in series. One end of the first light-emitting module is connected to the first input terminal. The second light-emitting module includes a plurality of second light sources connected in series. One end of the second light-emitting module is connected to the first input terminal. The current adjusting module includes a first switch and a second switch. The other end of the first light-emitting module is connected to the second input terminal via the first switch, and the other end of the second light-emitting module is connected to the second input terminal via the second switch. The first switch is connected to the second switch.

### BACKGROUND OF THE INVENTION

### 1. Field of the Invention

The present invention relates to a lighting device, in particular to a lighting device with current self-balancing function.

### 2. Description of the Prior Art

Due to manufacturing process variations, light-emitting diodes (LEDs) of the same model may exhibit certain voltage differences. To achieve more uniform light output, lighting device manufacturers typically connect multiple LEDs in series or connect a few LEDs in parallel to ensure the current passing through these LEDs is as consistent as possible. However, there are still current inconsistencies between multiple series circuits (or parallel circuits). If any one series circuit (or parallel circuit) has a low voltage, it will cause an increase in current within that series circuit (or parallel circuit), leading to overheating and potential damage to the lighting device. Therefore, the performance and reliability of the currently available lighting devices still require further improvement.

### SUMMARY OF THE INVENTION

One embodiment of the present invention provides a lighting device with current self-balancing function, which includes an input module, a first light-emitting module, a second light-emitting module, and a current adjusting module. The input module includes a first input terminal and a second input terminal. The first light-emitting module includes a plurality of first light sources connected in series. One end of the first light-emitting module is connected to the first input terminal. The second light-emitting module includes a plurality of second light sources connected in series. One end of the second light-emitting module is connected to the first input terminal. The current adjusting module includes a first switch and a second switch. The other end of the first light-emitting module is connected to the second input terminal via the first switch, and the other end of the second light-emitting module is connected to the second input terminal via the second switch. The first switch is connected to the second switch.

In one embodiment, the first end of the first switch is connected to the other end of the first light-emitting module and the second end of the first switch. The second end of the first switch is connected to the second end of the second switch. The first end of the second switch is connected to the other end of the second light-emitting module. The third end of the first switch and the third end of the second switch are connected to the second input terminal.

In one embodiment, the first switch and the second switch are bipolar junction transistors.

In one embodiment, the collector of the first switch is connected to the other end of the first light-emitting module and the base of the first switch. The base of the first switch is connected to the base of the second switch. The collector of the second switch is connected to the other end of the second light-emitting module. The emitter of the first switch and the emitter of the second switch are connected to the second input terminal.

In one embodiment, the current passing through the first light-emitting module is substantially equal to the current passing through the second light-emitting module.

In one embodiment, the lighting device further includes a third light-emitting module. The current adjusting module further includes a third switch. The third light-emitting module includes a plurality of third light sources connected in series. One end of the third light-emitting module is connected to the first input terminal and the other end of the third light-emitting module is connected to the second input terminal via the third switch. The third switch is connected to the first switch.

In one embodiment, the first end of the third switch is connected to the other end of the third light-emitting module. The second end of the third switch is connected to the second end of the first switch. The third end of the third switch is connected to the second input terminal.

In one embodiment, the first switch, second switch, and third switch are bipolar junction transistors.

In one embodiment, the collector of the first switch is connected to the other end of the first light-emitting module and the base of the first switch. The base of the first switch is connected to the base of the second switch and the base of the third switch. The collector of the second switch is connected to the other end of the second light-emitting module. The collector of the third switch is connected to the other end of the third light-emitting module. The emitter of the first switch, the emitter of the second switch and the emitter of the third switch are connected to the second input terminal.

In one embodiment, the current passing through the first light-emitting module, the current passing through the second light-emitting module, and the current passing through the third light-emitting module are substantially equal.

The lighting device with current self-balancing function in accordance with the embodiments of the present invention may have the following advantages:

(1) In one embodiment of the present invention, the lighting device includes an input module, a first light-emitting module, a second light-emitting module, and a current adjusting module. The input module includes a first input terminal and a second input terminal. The first light-emitting module includes a plurality of first light sources connected in series. One end of the first light-emitting module is connected to the first input terminal. The second light-emitting module includes a plurality of second light sources connected in series. One end of the second light-emitting module is connected to the first input terminal. The current adjusting module includes a first switch and a second switch. The other end of the first light-emitting module is connected to the second input terminal via the first switch, and the other end of the second light-emitting module is connected to the second input terminal via the second switch. The first switch is connected to the second switch. Via the circuit design of the current adjusting module, the current passing through the first light-emitting module and the current passing through the second light-emitting module are substantially equal, so the lighting device can achieve a current self-balancing effect. Thus, the efficiency of the lighting device can be greatly enhanced.

(2) In one embodiment of this invention, the lighting device includes a current adjusting module, which has the current self-balancing function. This function ensures that the current passing through the first light-emitting module and the second light-emitting module are substantially equal. This enables the lighting device to effectively achieve a current self-balancing effect, preventing overheating of the light-emitting modules and avoiding damage to the lighting device due to excessive heat. Consequently, the reliability of the lighting device is significantly improved, so the lighting device can conform to actual needs.

(3) In one embodiment of this invention, the lighting device includes the current adjusting module with the current self-balancing function, enabling the lighting device to effectively achieve a current self-balancing effect, thereby preventing overheating of the light-emitting modules and avoiding damage to the lighting device due to excessive heat. This effectively extends the service life of the lighting device so as to align with environmental protection requirements.

(4) In one embodiment of this invention, the circuit design of the current adjusting module in the lighting device is simple, and the lighting device does not require an additional controller to provide an effective current self-balancing function. As a result, the cost of the lighting device can be further reduced, allowing for broader applications and increased flexibility in use. Therefore, the lighting device can meet the diverse needs of different users.

(5) In one embodiment of this invention, the lighting device has a simple design, such that the lighting device can achieve the desired effect while minimizing costs. Thus, the lighting device is highly practical and suitable for various applications, aligning with future development trends.

Further scope of applicability of the present application will become more apparent from the detailed description given hereinafter. However, it should be understood that the detailed description and specific examples, while indicating exemplary embodiments of the present invention, are given by way of illustration only, since various changes and modifications within the spirit and scope of the present invention will become apparent to those skilled in the art from this detailed description.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

The present invention will become more fully understood from the detailed description given herein below and the accompanying drawings which are given by way of illustration only, and thus are not limitative of the present invention and wherein:

FIG. 1 is the circuit diagram of the lighting device with current self-balancing function in accordance with one embodiment of the present invention.

FIG. 2 is the circuit diagram of the lighting device with current self-balancing function in accordance with another embodiment of the present invention.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

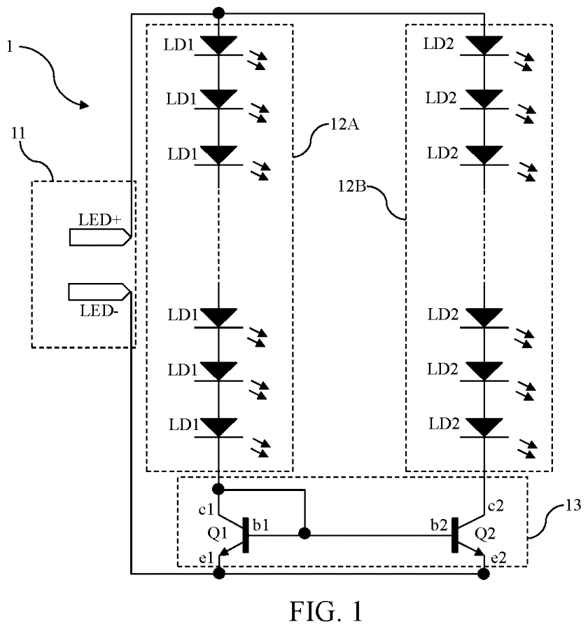

Please refer to FIG. 1, which is the circuit diagram of the lighting device with current self-balancing function in accordance with one embodiment of the present invention. As shown in FIG. 1, the lighting device 1 includes an input module 11, a first light-emitting module 12A, a second light-emitting module 12B, and a current adjusting module 13.

The input module 11 includes a first input terminal LED+ and a second input terminal LED−. The input module 11 is connected to a power supply module (not shown in the drawings), and the power supply module is connected to an external power source (such as a utility power or a generator). The power supply module may include a filter circuits, a rectifier circuit, a power factor correction circuit, and a voltage converter. The circuit structure and functions of the power supply module are well-known to those skilled in the art and will not be elaborated further. In one embodiment, the first input terminal LED+ serves as the positive input terminal, and the second input terminal LED− serves as the negative input terminal. In another embodiment, the polarity is reversed, with the first input terminal LED+ being the negative input terminal and the second input terminal LED− being the positive input terminal.

The first light-emitting module 12A includes a plurality of first light sources LD1, which are connected in series. One end of the first light-emitting module 12A (the positive electrode of the first light source LD1 at the start of the series) is connected to the first input terminal LED+. In one embodiment, the first light sources LD1 are light-emitting diodes (LEDs). In another embodiment, the first light sources LD1 may be LED arrays.

The second light-emitting module 12B includes a plurality of second light sources LD2, which are connected in series. One end of the second light-emitting module 12B (the positive electrode of the second light source LD2 at the start of the series) is connected to the first input terminal LED+. In one embodiment, the multiple second light sources LD2 are LEDs. In another embodiment, the multiple second light sources LD2 may be LED arrays.

The current adjusting module 13 includes a first switch Q1 and a second switch Q2. In this embodiment, the first switch Q1 and the second switch Q2 are bipolar junction transistors (BJTs). In another embodiment, the first switch Q1 and the second switch Q2 may be replaced by other equivalent switching components.

The other end of the first light-emitting module 12A is connected to the second input terminal LED− via the first switch Q1, and the other end of the second light-emitting module 12B is connected to the second input terminal LED− via the second switch Q2. The first switch Q1 and the second switch Q2 connected with each other. Specifically, the first end of the first switch Q1 is connected to the other end of the first light-emitting module 12A and the second end of the second switch Q2. The second end of the first switch Q1 is connected to the second end of the second switch Q2. The first end of the second switch Q2 is connected to the other end of the second light-emitting module 12B. The third end of the first switch Q1 and the third end of the second switch Q2 are connected to the second input terminal LED−. As stated earlier, in this embodiment, the first switch Q1 and the second switch Q2 are BJTs. The collector c1 of the first switch Q1 is connected to the other end of the first light-emitting module 12A (the negative electrode of the last first light source LD1) and the base b1 of the first switch Q1. The base b1 of the first switch Q1 is connected to the base b2 of the second switch Q2. The collector c2 of the second switch Q2 is connected to the other end of the second light-emitting module 12B (the negative electrode of the last second light source LD2). The emitter e1 of the first switch Q1 and the emitter e2 of the second switch Q2 are connected to the second input terminal LED−.

Through the aforementioned circuit design, the base b1 of the first switch Q1 is connected to the base b2 of the second switch Q2, so the current flowing into the base b1 of the first switch Q1 is essentially equal to the current flowing into the base b2 of the second switch Q2. Additionally, due to the characteristics of BJTS, the current flowing into the collector c1 of the first switch Q1 is β times the current flowing into the base b1 of the first switch Q1. Similarly, the current flowing into the collector c2 of the second switch Q2 is β times the current flowing into the base b2 of the second switch Q2. Thus, the current flowing into the collector c1 of the first switch Q1 is equal to the current flowing into the collector c2 of the second switch Q2. The current flowing into the collector c1 of the first switch Q1 is the current passing through the first light-emitting module 12A. The current flowing into the collector c2 of the second switch Q2 is the current passing through the second light-emitting module 12B. Consequently, the current passing through the first light-emitting module 12A is substantially equal to the current passing through the second light-emitting module 12B.

As set forth above, the lighting device 1 includes the input module 11, the first light-emitting module 12A, the second light-emitting module 12B, and the current adjusting module 13. The input module 11 includes the first input terminal LED+ and the second input terminal LED−. The first light-emitting module 12A includes the first light sources LD1 connected in series, with one end connected to the first input terminal LED+. The second light-emitting module 12B includes the second light sources LD2 connected in series, with one end connected to the first input terminal LED+. The current adjusting module 13 includes the first switch Q1 and the second switch Q2. The other end of the first light-emitting module 12A is connected to the second input terminal LED− via the first switch Q1, and the other end of the second light-emitting module 12B is connected to the second input terminal LED− via the second switch Q2. The first switch Q1 and the second switch Q2 are connected to each other. Through the circuit design of the current adjusting module 13, the current passing through the first light-emitting 12A can be substantially equal to the current passing through the second light-emitting modules 12B, such that the lighting device 1 can achieve the current self-balancing function. As a result, the efficiency of the lighting device 1 is significantly improved.

Furthermore, in this embodiment, the lighting device 1 effectively achieves the current self-balancing function, preventing overheating of the first and second light-emitting modules 12A and 12B and avoiding damage to the lighting device 1 due to overheating. This greatly enhances the reliability of the lighting device 1, making it more suitable for practical applications.

Additionally, in this embodiment, the lighting device 1 features the current adjusting module 13 with the current self-balancing function. This allows the lighting device 1 to effectively achieve the current self-balancing effect, preventing overheating of the first and second light-emitting modules 12A and 12B and avoiding damage to the lighting device 1 due to overheating. Consequently, the service life of the lighting device 1 is effectively extended, meeting environmental protection requirements. Moreover, the cost of the lighting device 1 can be further reduced, making its application more widespread and flexible. As a result, the lighting device 1 can meet the diverse needs of different users.

The embodiment just exemplifies the present invention and is not intended to limit the scope of the present invention; any equivalent modification and variation according to the spirit of the present invention is to be also included within the scope of the following claims and their equivalents.

It is worthy to point out that lighting device manufacturers typically connect multiple LEDs in series or connect a few LEDs in parallel to ensure the current passing through these LEDs is as consistent as possible. However, there are still current inconsistencies between multiple series circuits (or parallel circuits). If any one series circuit (or parallel circuit) has a low voltage, it will cause an increase in current within that series circuit (or parallel circuit), leading to overheating and potential damage to the lighting device. Therefore, the performance and reliability of the currently available lighting devices still require further improvement. By contrast, according to one embodiment of the present invention, the lighting device includes an input module, a first light-emitting module, a second light-emitting module, and a current adjusting module. The input module includes a first input terminal and a second input terminal. The first light-emitting module includes a plurality of first light sources connected in series. One end of the first light-emitting module is connected to the first input terminal. The second light-emitting module includes a plurality of second light sources connected in series. One end of the second light-emitting module is connected to the first input terminal. The current adjusting module includes a first switch and a second switch. The other end of the first light-emitting module is connected to the second input terminal via the first switch, and the other end of the second light-emitting module is connected to the second input terminal via the second switch. The first switch is connected to the second switch. Via the circuit design of the current adjusting module, the current passing through the first light-emitting module and the current passing through the second light-emitting module are substantially equal, so the lighting device can achieve a current self-balancing effect. Thus, the efficiency of the lighting device can be greatly enhanced.

Also, according to one embodiment of the present invention, the lighting device includes a current adjusting module, which has the current self-balancing function. This function ensures that the current passing through the first light-emitting module and the second light-emitting module are substantially equal. This enables the lighting device to effectively achieve a current self-balancing effect, preventing overheating of the light-emitting modules and avoiding damage to the lighting device due to excessive heat. Consequently, the reliability of the lighting device is significantly improved, so the lighting device can conform to actual needs.

Further, according to one embodiment of the present invention, the lighting device includes the current adjusting module with the current self-balancing function, enabling the lighting device to effectively achieve a current self-balancing effect, thereby preventing overheating of the light-emitting modules and avoiding damage to the lighting device due to excessive heat. This effectively extends the service life of the lighting device so as to align with environmental protection requirements.

Moreover, according to one embodiment of the present invention, the circuit design of the current adjusting module in the lighting device is simple, and the lighting device does not require an additional controller to provide an effective current self-balancing function. As a result, the cost of the lighting device can be further reduced, allowing for broader applications and increased flexibility in use. Therefore, the lighting device can meet the diverse needs of different users.

Furthermore, according to one embodiment of the present invention, the lighting device has a simple design, such that the lighting device can achieve the desired effect while minimizing costs. Thus, the lighting device is highly practical and suitable for various applications, aligning with future development trends. As described above, the lighting device with current self-balancing function according to the embodiments of the present invention can achieve great technical effects.

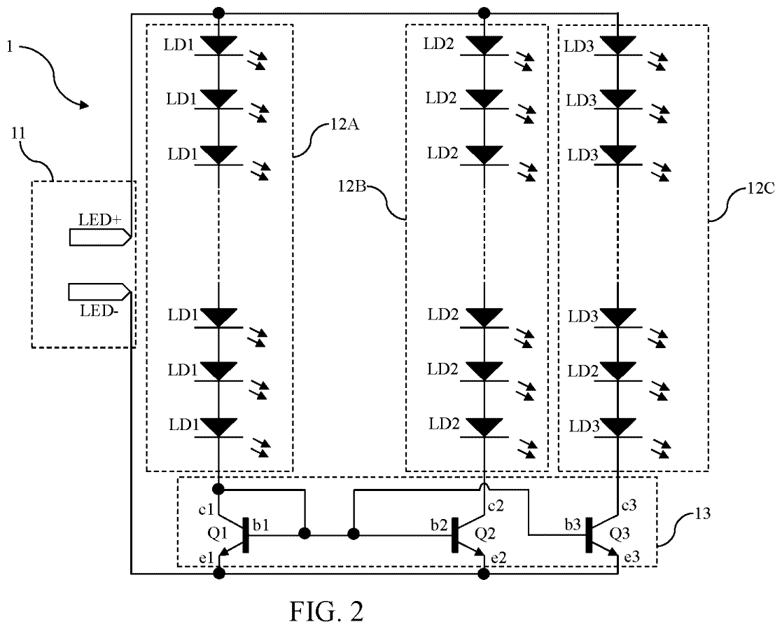

Please refer to FIG. 2, which is the circuit diagram of the lighting device with current self-balancing function in accordance with another embodiment of the present invention. As shown FIG. 2, the lighting device 1 includes an input module 11, a first light-emitting module 12A, a second light-emitting module 12B, a third light-emitting module 12C, and a current adjusting module 13. In this embodiment, the lighting device 1 has three light-emitting modules, but the number of light-emitting modules is merely exemplary. In another embodiment, the lighting device 1 may include four or more light-emitting modules.

The input module 11 includes a first input terminal LED+ and a second input terminal LED−. The input module 11 is connected to a power supply module (not shown in the drawings), and the power supply module is connected to an external power source (e.g., a utility power, a generator, etc.). The power supply module may include a filter circuit, a rectifier circuit, a power factor correction circuit, a voltage transformer, etc.; the structure and function of the power supply module are well known to those skilled in the art and will not be elaborated upon here. The first input terminal LED+ can serve as a positive input terminal, while the second input terminal LED− can serve as a negative input terminal.

The first light-emitting module 12A includes a plurality of first light sources LD1, which are connected in series. One end of the first light-emitting module 12A (the positive electrode of the first light source LD1 at the start of the series) is connected to the first input terminal LED+. The first light sources LD1 may be LEDS.

The second light-emitting module 12B includes a plurality of second light sources LD2, which are connected in series. One end of the second light-emitting module 12B (the positive electrode of the second light source LD2 at the start of the series) is connected to the first input terminal LED+. The second light sources LD2 may be LEDS.

The third light-emitting module 12C includes a plurality of third light sources LD3, which are connected in series. One end of the third light-emitting module 12C (the positive electrode of the third light source LD3 at the start of the series) is connected to the first input terminal LED+. The third light sources LD3 may also be LEDs.

The current adjusting module 13 includes a first switch Q1, a second switch Q2, and a third switch Q3. In this embodiment, the first switch Q1, the second switch Q2, and the third switch Q3 are BJTs. In another embodiment, the first switch Q1, the second switch Q2, and the third switch Q3 may be other similar switching components.

The other end of the first light-emitting module 12A is connected to the second input terminal LED− via the first switch Q1, the other end of the second light-emitting module 12B is connected to the second input terminal LED− via the second switch Q2, and the other end of the third light-emitting module 12C is connected to the second input terminal LED− via the third switch Q3. The first switch Q1, the second switch Q2, and the third switch Q3 are connected to each other. Specifically, the first end of the first switch Q1 is connected to the other end of the first light-emitting module 12A and the second end of the first switch Q2. The second end of the first switch Q1 is connected to the second end of the second switch Q2 and the second end of the third switch Q3. The first end of the second switch Q2 is connected to the other end of the second light-emitting module 12B. The third end of the first switch Q1, the third end of the second switch Q2, and the third end of the third switch Q3 are connected to the second input terminal LED−. As noted earlier, in this embodiment, the first switch Q1, the second switch Q2, and the third switch Q3 are BJTs. The collector c1 of the first switch Q1 is connected to the other end of the first light-emitting module 12A (the negative electrode of the last first light source LD1) and the base b1 of the first switch Q1. The base b1 of the first switch Q1 is connected to the bases b2 of the second switch Q2 and the base b3 of the third switch Q3. The collector c2 of the second switch Q2 is connected to the other end of the second light-emitting module 12B (the negative electrode of the last second light source LD2). The collector c3 of the third switch Q3 is connected to the other end of the third light-emitting module 12C (the negative electrode of the last third light source LD3). The emitter e1 of the first switch Q1, the emitter e2 of the second switch Q2 and the emitter e3 of the third switch Q3 are connected to the second input terminal LED−.

With the above circuit design, the base b1 of the first switch Q1 is connected to the bases b2 of the second switch Q2 and the base b3 of the third switch Q3, so the current flowing into the base b1 of the first switch Q1 is substantially equal to the current flowing into the base b2 of the second switch Q2 and the base b3 of the third switch Q3. Moreover, due to the characteristics of BJTs, the current flowing into the collector c1 of the first switch Q1 is β times the current flowing into its base b1 of the first switch Q1; similarly, the current flowing into the collector c2 of the second switch Q2 is β times the current flowing into the base b2 of the second switch Q2, and the current flowing into the collector c3 of the third switch Q3 is β times the current flowing into the base b3 of the third switch A3. Therefore, the current flowing into the collector c1 of the first switch Q1 is substantially equal to the current flowing into the collector c2 of the second switch Q2 and the collector c3 of the third switch Q3. The current flowing into the collector c1 of the first switch Q1 is the current passing through the first light-emitting module 12A, the current flowing into the collector c2 of the second switch Q2 is the current passing through the second light-emitting module 12B, and the current flowing into the collector c3 of the third switch Q3 is the current passing through the third light-emitting module 12C. Consequently, the current through the first light-emitting module 12A is substantially equal to the current passing through the second light-emitting module 12B and the current passing through the third light-emitting module 12C.

Similarly, with the current adjusting module 13's circuit design, the currents through the first light-emitting module 12A, the second light-emitting module 12B, and the third light-emitting module 12C are essentially equal. Hence, the lighting device 1 can achieve a current self-balancing effect and other related technical effects, meeting practical application requirements.

The embodiment just exemplifies the present invention and is not intended to limit the scope of the present invention; any equivalent modification and variation according to the spirit of the present invention is to be also included within the scope of the following claims and their equivalents.

To sum up, according to one embodiment of the present invention, the lighting device includes an input module, a first light-emitting module, a second light-emitting module, and a current adjusting module. The input module includes a first input terminal and a second input terminal. The first light-emitting module includes a plurality of first light sources connected in series. One end of the first light-emitting module is connected to the first input terminal. The second light-emitting module includes a plurality of second light sources connected in series. One end of the second light-emitting module is connected to the first input terminal. The current adjusting module includes a first switch and a second switch. The other end of the first light-emitting module is connected to the second input terminal via the first switch, and the other end of the second light-emitting module is connected to the second input terminal via the second switch. The first switch is connected to the second switch. Via the circuit design of the current adjusting module, the current passing through the first light-emitting module and the current passing through the second light-emitting module are substantially equal, so the lighting device can achieve a current self-balancing effect. Thus, the efficiency of the lighting device can be greatly enhanced.

Also, according to one embodiment of the present invention, the lighting device includes a current adjusting module, which has the current self-balancing function. This function ensures that the current passing through the first light-emitting module and the second light-emitting module are substantially equal. This enables the lighting device to effectively achieve a current self-balancing effect, preventing overheating of the light-emitting modules and avoiding damage to the lighting device due to excessive heat. Consequently, the reliability of the lighting device is significantly improved, so the lighting device can conform to actual needs.

Further, according to one embodiment of the present invention, the lighting device includes the current adjusting module with the current self-balancing function, enabling the lighting device to effectively achieve a current self-balancing effect, thereby preventing overheating of the light-emitting modules and avoiding damage to the lighting device due to excessive heat. This effectively extends the service life of the lighting device so as to align with environmental protection requirements.

Moreover, according to one embodiment of the present invention, the circuit design of the current adjusting module in the lighting device is simple, and the lighting device does not require an additional controller to provide an effective current self-balancing function. As a result, the cost of the lighting device can be further reduced, allowing for broader applications and increased flexibility in use. Therefore, the lighting device can meet the diverse needs of different users.

Furthermore, according to one embodiment of the present invention, the lighting device has a simple design, such that the lighting device can achieve the desired effect while minimizing costs. Thus, the lighting device is highly practical and suitable for various applications, aligning with future development trends.

It will be apparent to those skilled in the art that various modifications and variations can be made to the disclosed embodiments. It is intended that the specification and examples be considered as exemplary only, with a true scope of the present invention being indicated by the following claims and their equivalents.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A lighting device with current self-balancing function, comprising:
an input module comprising a first input terminal and a second input terminal,
a first light-emitting module comprising a plurality of first light sources connected in series, wherein one end of the first light-emitting module is connected to the first input terminal;
a second light-emitting module comprising a plurality of second light sources connected in series, wherein one end of the second light-emitting module is connected to the first input terminal; and
a current adjusting module comprising a first switch and a second switch;
wherein another end of the first light-emitting module is connected to the second input terminal via the first switch, and another end of the second light-emitting module is connected to the second input terminal via the second switch, wherein the first switch is connected to the second switch.

2. The lighting device with current self-balancing function as claimed in claim 1, wherein a first end of the first switch is connected to another end of the first light-emitting module and a second end of the first switch, wherein the second end of the first switch is connected to a second end of the second switch, wherein a first end of the second switch is connected to another end of the second light-emitting module, wherein a third end of the first switch and a third end of the second switch are connected to the second input terminal.

3. The lighting device with current self-balancing function as claimed in claim 2, wherein the first switch and the second switch are bipolar junction transistors.

4. The lighting device with current self-balancing function as claimed in claim 3, wherein a collector of the first switch is connected to another end of the first light-emitting module and a base of the first switch, wherein the base of the first switch is connected to a base of the second switch, wherein a collector of the second switch is connected to another end of the second light-emitting module, wherein an emitter of the first switch and an emitter of the second switch are connected to the second input terminal.

5. The lighting device with current self-balancing function as claimed in claim 4, wherein a current passing through the first light-emitting module is substantially equal to a current passing through the second light-emitting module.

6. The lighting device with current self-balancing function as claimed in claim 1, further comprising a third light-emitting module, wherein the current adjusting module further comprises a third switch, and the third light-emitting module comprises a plurality of third light sources connected in series, wherein one end of the third light-emitting module is connected to the first input terminal and another end of the third light-emitting module is connected to the second input terminal via the third switch, and the third switch is connected to the first switch.

7. The lighting device with current self-balancing function as claimed in claim 6, wherein a first end of the third switch is connected to another end of the third light-emitting module, wherein a second end of the third switch is connected to a second end of the first switch, wherein a third end of the third switch is connected to the second input terminal.

8. The lighting device with current self-balancing function as claimed in claim 7, wherein the first switch, second switch, and third switch are bipolar junction transistors.

9. The lighting device with current self-balancing function as claimed in claim 8, wherein a collector of the first switch is connected to another end of the first light-emitting module and a base of the first switch, wherein the base of the first switch is connected to a base of the second switch and a base of the third switch, wherein a collector of the second switch is connected to another end of the second light-emitting module, wherein a collector of the third switch is connected to another end of the third light-emitting module, wherein an emitter of the first switch, an emitter of the second switch and an emitter of the third switch are connected to the second input terminal.

10. The lighting device with current self-balancing function as claimed in claim 9, wherein a current passing through the first light-emitting module, a current passing through the second light-emitting module, and a current passing through the third light-emitting module are substantially equal.
